(19) United States
(12) Patent Application Publication
(10) Pub. No.: US 2025/0209945 A1
(43) Pub. Date: Jun. 26, 2025

(54) SPECTACLE-TYPE DISPLAY DEVICE

(71) Applicant: Quanta Computer Inc., Taoyuan City (TW)

(72) Inventors: Jung-Wen CHANG, Taoyuan City (TW); Chien-Hung LIN, Taoyuan City (TW)

(21) Appl. No.: 18/747,609

(22) Filed: Jun. 19, 2024

(30) Foreign Application Priority Data
Dec. 26, 2023 (TW) 112150753

(51) Int. Cl. G09G 3/00; G02B 27/01; G02C 11/00; G10L 15/08

(52) U.S. Cl. CPC G09G 3/001; G02B 27/0176; G02C 11/10; G10L 15/08; G02B 2027/0138; G02B 2027/014; G02B 2027/0178; G09G 2340/0464

(57) ABSTRACT

Embodiments of the present disclosure provide a spectacle-type display device, which includes a lens, a micro project device, a memory, and a control unit. The control unit is configured to read a line in the memory. The control unit is further configured to compare an input voice and the line to generate a comparison result. The control unit is further configured to determine to output the line according to the comparison result. The control unit is further configured to control the micro project device to project the line on the lens, in response to a determination to output the line.

### CROSS REFERENCE TO RELATED APPLICATIONS

This application claims the benefit of Taiwan Application No. 112150753, filed on Dec. 26, 2023, the entirety of which is incorporated by reference herein.

### BACKGROUND OF THE INVENTION

### Field of the Invention

The present invention relates to spectacle-type display devices, and, in particular, to spectacle-type display devices configured to display subtitles.

### Description of the Related Art

When watching a stage show, hearing-impaired or hard-of-hearing users have a poor viewing experience, because they can hardly hear the lines of dialogue spoken by the actors. To solve this problem, staff members in the theater may operate a caption machine to show corresponding subtitles when they hear the lines. However, this solution requires abundant human resources, and the staff may make mistakes. Thus, how to correctly and immediately display the lines as spoken by the actors is a problem in this field that needs to be solved.

### BRIEF SUMMARY OF THE INVENTION

Embodiments of the present disclosure provides a spectacle-type display device, which includes a lens, a micro project device, a memory, and a control unit. The control unit is configured to read a line in the memory. The control unit is further configured to compare an input voice and the line to generate a comparison result. The control unit is further configured to determine to output the line according to the comparison result. The control unit is further configured to control the micro project device to project the line on the lens, in response to a determination to output the line.

### BRIEF DESCRIPTION OF THE DRAWINGS

The present invention can be more fully understood by reading the subsequent detailed description and examples with references made to the accompanying drawings, wherein:

FIG. 1A is a schematic diagram of the spectacle-type display device in accordance with an embodiment of the present disclosure;

FIG. 1B is a block diagram of the spectacle-type display device in accordance with an embodiment of the present disclosure;

FIG. 2A is a schematic diagram of the spectacle-type display device in accordance with another embodiment of the present disclosure;

FIG. 2B is a block diagram of the spectacle-type display device in accordance with another embodiment of the present disclosure;

FIG. 3 is a flow diagram of a method in accordance to embodiments of the present disclosure;

FIG. 4 is a flow diagram of a method in accordance to embodiments of the present disclosure;

FIG. 5 is a flow diagram of a method in accordance to embodiments of the present disclosure;

FIG. 6A is an illustrative diagram in accordance to the embodiments of the present disclosure;

FIG. 6B is an illustrative diagram in accordance to the embodiments of the present disclosure; and

FIG. 6C is an illustrative diagram in accordance to the embodiments of the present disclosure;

### DETAILED DESCRIPTION OF THE INVENTION

The following description is made for the purpose of illustrating the general principles of the invention and should not be taken in a limiting sense. The scope of the invention is best determined by reference to the appended claims.

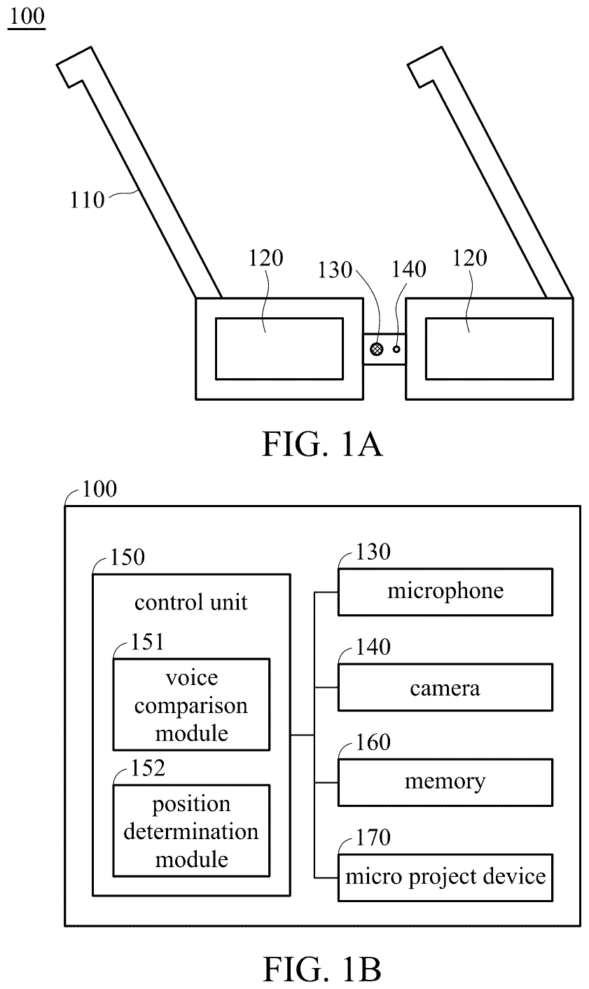

Refer to FIGS. 1A and 1B. FIG. 1A is a schematic diagram of the spectacle-type display device 100 in accordance with an embodiment of the present disclosure, and FIG. 1B is a block diagram of the spectacle-type display device 100 in accordance with an embodiment of the present disclosure. As shown in FIG. 1A, the spectacle-type display device 100 comprises the frame 110, lenses 120, the microphone 130, and the camera 140. The frame 110 supports and holds lenses 120, microphone 130, and camera 140. Lenses 120 are transparent. The microphone 130 and the camera 140 may, for example but not limited to, be on the frame 110 between two lenses 120 (e.g. the bridge). Alternatively, the microphone 130 and the camera 140 may both be on the left or right front (i.e. frame surrounding left or right lenses), or respectively be on the left and right fronts. Alternatively, the microphone 130 and/or the camera 140 may be mounted on the side of the spectacle-type display device 100 (e.g. being mounted on the temples). As shown in FIG. 1B, the spectacle-type display device 100 comprises the microphone 130, the camera 140, the control unit 150, the memory 160, and the micro project device 170. In this embodiment, control unit 150 is configured to operate or implement a voice comparison module 151 and a position determination module 152. The microphone 130, the camera 140, the control unit 150, the memory 160, and the micro project device 170 connect with each other and may exchange information with each other.

The microphone 130 is configured to receive voice and convert the received voice into electronic signals. In some embodiments, the microphone 130 is a directional microphone. The directional microphone is able to receive voice from a certain direction and ignore other voice from the direction other than the certain direction. Thus, using a directional microphone can ignore the voice of other audiences besides the user (who is wearing the spectacle-type display device 100) and achieve a better reception effect. The camera 140 is configured to capture images and convert the captured images into electronic signals. For example, the camera 140 is charge coupled device (CCD) or complementary metal-oxide semiconductor (CMOS) image sensor.

The control unit 150 provides computation and process ability. The control unit 150 is able to perform programs, software, firmware, and modules. Moreover, the control unit 150 is configured to control the frame 110, lenses 120, the microphone 130, and the camera 140 (e.g. using instructions). For example, the control unit 150 may comprise general purpose processor, central process unit, and/or micro control unit.

The voice comparison module 151 is configured to receive the input voice (speech) from the microphone 130. The voice comparison module 151 determines the line (i.e. string) to be output according to the input voice. The position determination module 152 receives the input image from the camera 140. The position determination module 152 is configured to determine the position where the line is displayed (projected) on the lenses 120 according to the input image. The voice comparison module 151 and the position determination module 152 will be described in more detail below.

The memory 160 stores data required by the operations of the control unit 150, such as program codes and lines (string). The control unit 150 is able to access and write to the memory 161. In some embodiments, the memory 161 stores program code. The program codes can be read and operated by the control unit 150 and cause the control unit 150 to operate or implement the voice comparison module 151, the position determination module 152, and methods in accordance with the embodiments of the present disclosure. The memory 160 may comprise non-volatile memories, such as read only memory (ROM) and flash memory. The memory 160 may also comprise volatile memories, such as dynamic random access memory (DRAM) and static random access memory (SRAM).

The micro project device 170 is able to project a given line on a specific position of the lenses 120, under the control of the control unit 150. Thus, the user can simultaneously see the lines and the performance through the lenses 120.

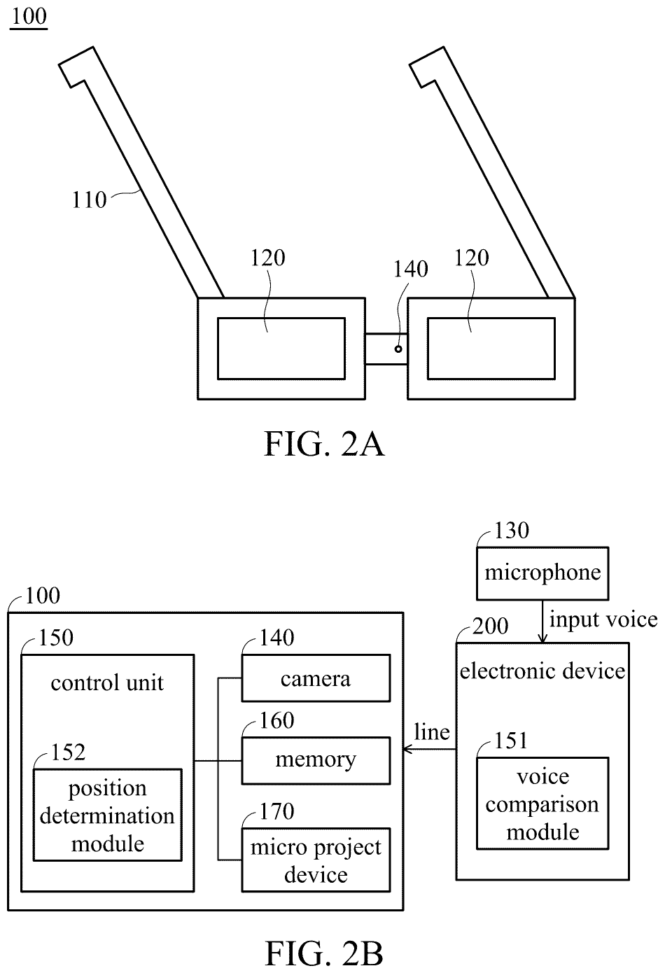

Refer to FIGS. 2A and 2B. FIG. 2A is a schematic diagram of the spectacle-type display device 100 in accordance with another embodiment of the present disclosure, and FIG. 2B is a block diagram of the spectacle-type display device 100 in accordance with another embodiment of the present disclosure. As shown in FIGS. 2A and 2B, in this embodiment, the spectacle-type display device 100 doesn't include the microphone 130. The microphone 130 separates from the spectacle-type display device 100. The microphone 130 may be placed in front of the stage or on the stage in order to achieve a better reception effect. Furthermore, in the situation that the microphone 130 is mounted on the spectacle-type display device 100 (as shown in FIG. 1A), it is hard for the microphone 130 to receive the sound from the stage, when the user turns his/her head. The embodiment illustrated in FIGS. 2A and 2B can solve this problem. Refer to FIG. 2B, in this embodiment, the voice comparison module 151 is operated by an electronic device 200 which is separate with the spectacle-type display device 100. The electronic device 200 has the ability to compute and process data. For example, the electronic device 200 is a computer, a notebook computer, or a control box. In some embodiments, the electronic device 200 comprises a processor and a memory. The microphone 130 transmits the received input voice (audio signal) to the electronic device 200. The voice comparison module 151 determines the line (string) according to the input voice. Then, the electronic device 200 transmits the determined line to the spectacle-type display device 100. The spectacle-type display device 100 determines the display position of the received line using the position determination module 152 and displays the received line.

In the embodiment shown in FIGS. 2A and 2B, the control unit 150 only needs to display the received line. Thus, the control unit 150 can be implemented with simple hardware, and thus the hardware cost and the volume of the spectacle-type display device 100 can be reduced. The microphone 130, the electronic device 200, and the spectacle-type display device 100 may communicate with each other using any known communication technology, such as Wi-Fi and Bluetooth. In some embodiments, the electronic device 200 transmits the line to a cellphone, and the cellphone transmits the line to the spectacle-type display device 100. By doing so, the hardware circuit of the spectacle-type display device 100 can be further simplified.

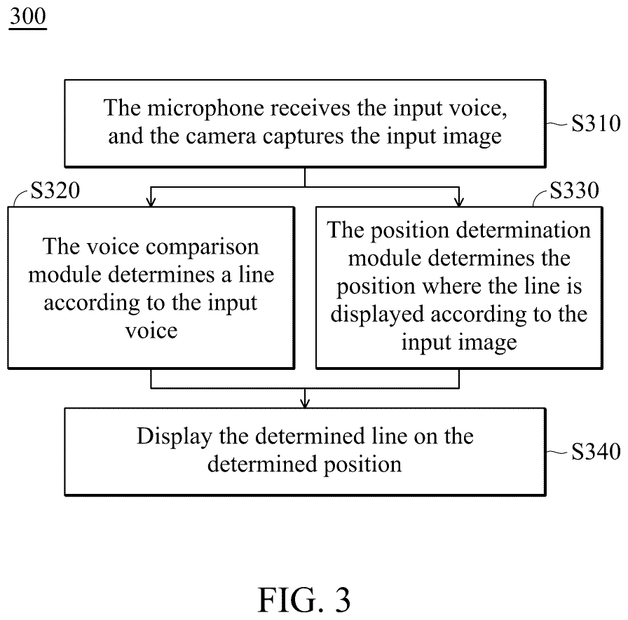

Refer to FIG. 3. FIG. 3 is a flow diagram of a method 300 in accordance to embodiments of the present disclosure. Method 300 may be implemented in the embodiments shown in FIGS. 1A, 1B, 2A, and 2B. Method 300 starts from step S310. In step S310, the microphone 130 receives the input voice, and the camera 140 captures the input image. Then, method 300 proceeds to step S320 and step S330. In some embodiments, step S320 and step S330 are simultaneously performed in parallel. In step S320, the voice comparison module 151 determines a line according to the input voice. The voice comparison module 151 outputs the determined line. In step S330, the position determination module 152 determines the position where the line is displayed (on the lenses 120) according to the input image. Then, method 300 proceeds to step S340. In step S340, the control unit 150 receives the line output from the voice comparison module 151 and the position determined by the position determination module 152. The control unit 150 controls the micro project device 170 to display the line determined by the voice comparison module 151 on the position determined by the position determination module 152.

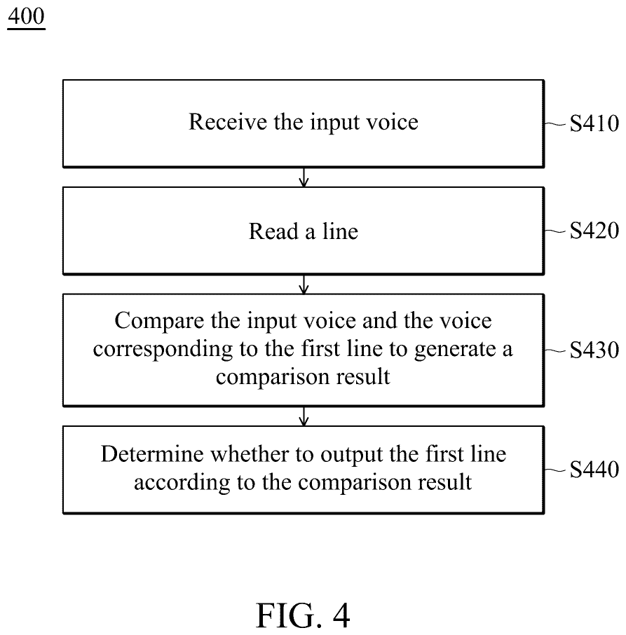

Refer to FIG. 4. FIG. 4 is a flow diagram of a method 400 in accordance to embodiments of the present disclosure. Method 400 may be implemented in the embodiments shown in FIGS. 1A, 1B, 2A, and 2B. Method 400 is a method for determining the line (string) according to the input voice in the step S320. Thus, method 400 may be performed by the voice comparison module 151. In step S410, the voice comparison module 151 receives the input voice from the microphone 130. The voice comparison module 151 may receive the input voice from the microphone 130 through wire (FIGS. 1A and 1B) or wireless (FIGS. 2A and 2B) communication. The input voice is an audio signal, for example, representing at least one sentence spoken by a human. For example, the input voice is lines spoken by the actor on the stage.

In step S420, the voice comparison module 151 reads a first line among a plurality of lines (string) stored in the memory. The lines stored in the memory may be referred to as a line library. For example, when the voice comparison module 151 is operated by the control unit 150, the voice comparison module 151 reads the lines stored in the memory 160. Alternatively, when the voice comparison module 151 is operated by the electronic device 200, the voice comparison module 151 reads the lines stored in the memory of the electronic device 200. In other embodiments, the voice comparison module 151 may read the lines stored in a server. These lines are the line as written in the script, and the actors will perform according to the script. In other words, the input voice corresponds to one of the lines in the line library. These lines are stored in the memory in advance (e.g., before the performance starts). In some embodiments, these lines are stored in the memory before step S410 or step S420. In some embodiments, these lines are stored in the memory as a text file.

In step S430, the voice comparison module 151 compares the input voice and the voice corresponding to the first line (i.e. the vocalization of the first line) to generate a comparison result. Thus, the voice comparison module 151 determines whether the first line among the lines matches to the input voice. As mentioned above, the first line is a text file, and the voice corresponding to the first line is an audio signal, which represents the pronunciation of the first line. In some embodiments, the voice comparison module 151 determines whether the input voice is the same as the voice corresponding to the first line using voiceprint comparison technology. In some embodiments, the memory which stores the lines also stores voices (audio signals) corresponding to these lines. The voice comparison module 151 reads the voices stored in the memory to determine whether these voices are the same as the input voice. In another embodiment, the voice comparison module 151 converts the input voice into texts using Speech-to-Text or speech recognition technology to determine whether the input voice is the same as the first line. By doing so, it is not necessary to store the voices (audio signal) corresponding to the lines.

In some embodiments, the comparison result is the accuracy rate. The input voice can be separated into multiple voice words (also referred to as spoken words). Each voice word is an audio signal representing the pronunciation of a word (a vocabulary). The first line can be separated into multiple line words (also referred to as written words). The accuracy rate is calculated as follows:
number of matching words/number of the line words
   The number of matching words is the number of voice words that match the line words. Specifically, the number of matching words is the number of voice words that are the same as the pronunciation corresponding to the line words (the vocalization of the line words). In some embodiments, the voice comparison module 151 determines whether each voice word of the input voice is the same as the pronunciation corresponding to each line word of the first line in order. In other words, the voice comparison module 151 first determines whether the first voice word (such as the first word at the beginning of the input voice) of the input voice is the same as the pronunciation corresponding to the first line word (such as the first word at the beginning of the first line) of the first line. Then, the voice comparison module 151 determines whether the second voice word (such as the voice word next to the first voice word) of the input voice is the same as the pronunciation corresponding to the second line word (such as the line word next to the first line word) of the first line, and so on. The voice comparison module 151 repeatedly performs the above mentioned operations until all the voice words of the input voice or all the line words of the first line have been determined. In some embodiments, the voice comparison module 151 skips the first voice word, when the voice comparison module 151 determines that the first voice word isn't the same as the pronunciation corresponding to the first line word of the first line. Then, the voice comparison module 151 compares the second voice word of the input voice and the pronunciation corresponding to the first line word of the first line, and compares the third voice word (the voice word next to the second voice word) of the input voice and the pronunciation corresponding to the second line word (the line word next to the first line word) of the first line in order. Alternatively, the voice comparison module 151 may skip the first line word of the first line. Then, the voice comparison module 151 compares the first voice word of the input voice and the pronunciation corresponding to the second line word of the first line, and compares the second voice word of the input voice and the pronunciation corresponding to the third line word of the first line in order.

In step S440, the voice comparison module 151 determines whether to output the first line according to the comparison result (accuracy rate). In some embodiments, the voice comparison module 151 outputs the first line (for example, to the control unit 150), when the voice comparison module 151 determines that the accuracy rate is higher than a first threshold. For example, the first threshold is 80%. Thus, the spectacle-type display device 100 can display the correct line, even if the line spoken by the actor has a minor difference with the line as written in the script. If the voice comparison module 151 determines that the first line doesn't match to the input voice, for example, the comparison result (accuracy rate) is lower than the first threshold and higher than a second threshold, the voice comparison module 151 continues to compare the input voice and other lines (i.e. a second line) in the lines library. When the voice comparison module 151 determines that the accuracy rate is lower than the second threshold, the voice comparison module 151 doesn't output the first line (e.g. to the control unit 150). For example, the second threshold is 20%. Thus, the spectacle-type display device 100 doesn't display any line when the actor forgets the line (and doesn't speak any line).

Refer to Table 1 and Table 2, Table 1 and Table 2 illustrate the relationship between the input voice, the line in the lines library, and the line output from the voice comparison module 151.

TABLE 1

| line in the lines | | | |
|---|---|---|---|
| library | input voice | output line | description |
| A: What's in your | A: What's in your | A: What's in your | perfectly matched, |
| lunch box? | lunch box? | lunch box? | output the line |
| B: I have rice, pork, | B: I have rice, pork, | B: I have rice, | accuracy rate is |
| egg, and some | egg, and some | pork, egg, and | higher than 80%, |
| vegetable. What do | vegetable. What you | some vegetable. | output the line |
| you have? | have? (“do” is | What do you | |
| | missed) | have? | |
| A: I have some | A: I have some | A: I have some | perfectly matched, |
| sausages, noodle and | sausages, noodle and | sausages, noodle | output the line |
| vegetable. | vegetable. | and vegetable. | |

TABLE 2

| line in the lines | | | |
|---|---|---|---|
| library | input voice | output line | description |
| A: how was your | A: how was your | A: how was your | perfectly matched, |
| new school? | new school? | new school? | output the line |
| B: it was cool. I | B: it was cool. I have | B: it was cool. I have | perfectly matched, |
| have many friends | many friends now. | many friends now. | output the line |
| now. | | | |
| B: My teachers are | B: forgets the line | NA | Do not output the |
| teachers are good, | and doesn't speak | | line |
| too. | the line | | |
| It's good to hear | It's good to hear | It's good to hear | perfectly matched, |
| that. | that. | that. | output the line |

Thus, the voice comparison module 151 in the above embodiments determines whether the input voice matches to the known (given) words, instead of converting the input voice into words. In other words, the voice comparison module 151 in accordance with the embodiments of the present disclosure doesn't perform language understanding and sentence generation. Comparing to speech recognition (including language understanding and sentence generation), the voice comparison module 151 in accordance with embodiments of the present disclosure requires less computation. Thus, the voice comparison module 151 in accordance with the embodiments of the present disclosure can instantly output the line spoken by the actor. Moreover, the voice comparison module 151 in accordance with the embodiments of the present disclosure outputs the words which are stored in the memory in advance. By doing so, outputting the wrong content because of a wrong input voice can be avoid. Particularly, the voice comparison module 151 in accordance with the embodiments of the present disclosure can solve the problem of determining homophones (words having the same pronunciation) and words having close pronunciations.

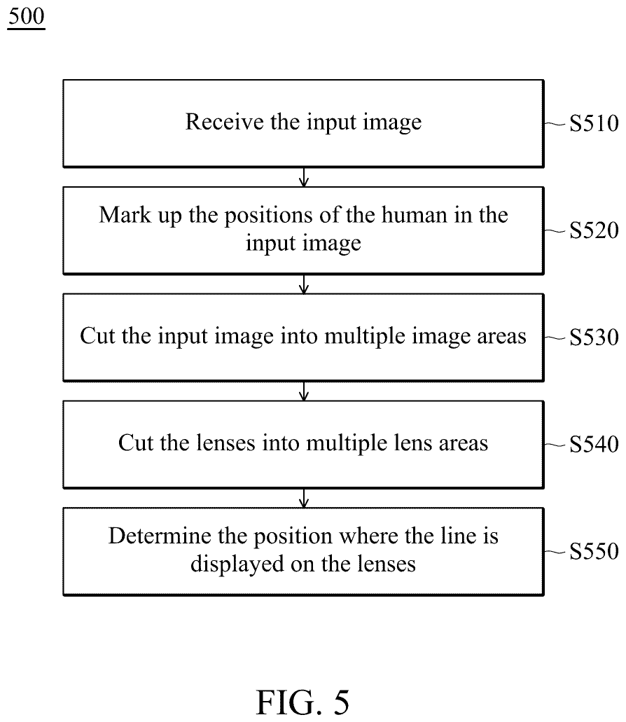

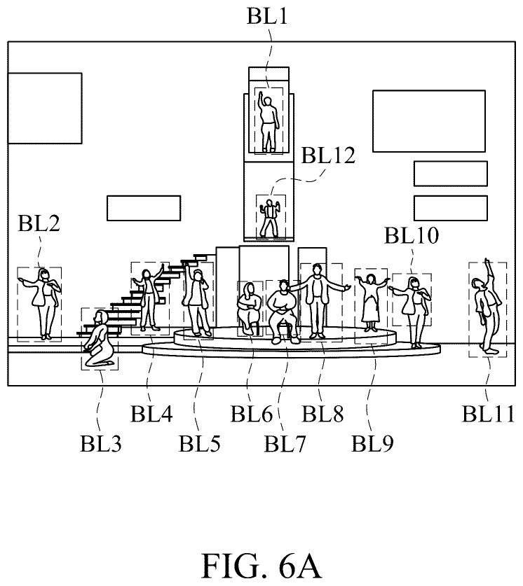

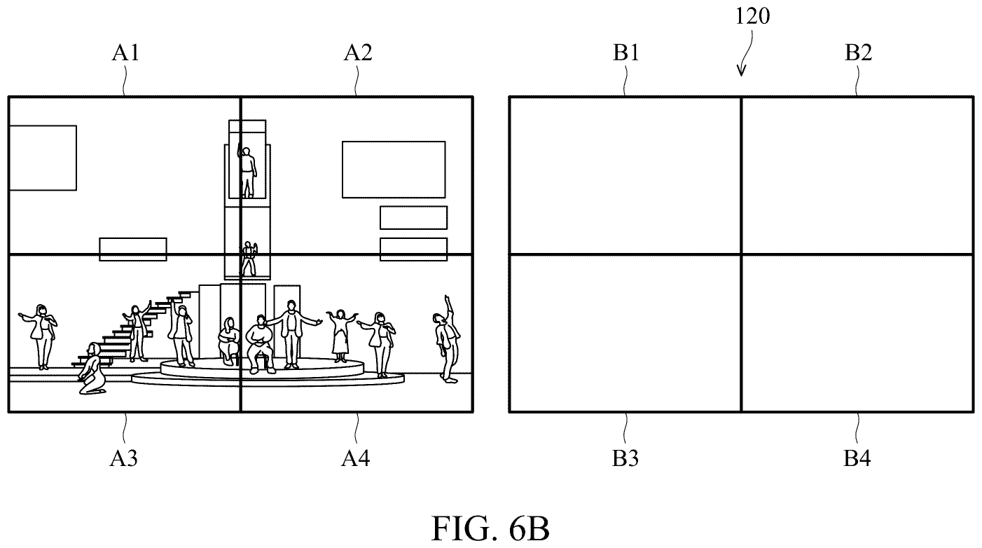

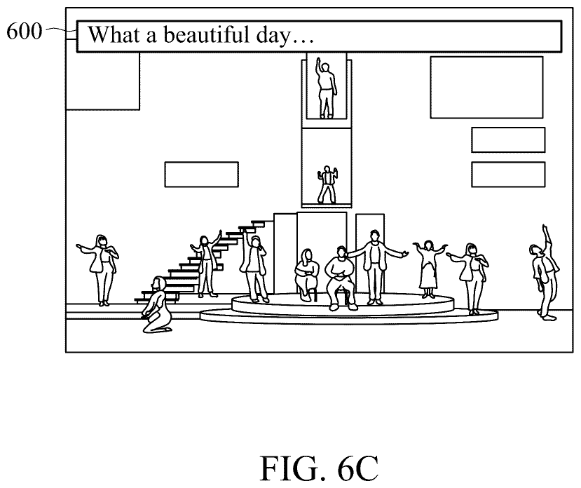

Refer to FIG. 5, FIG. 5 is a flow diagram of a method 500 in accordance to embodiments of the present disclosure. Method 500 may be implemented in the embodiments shown in FIGS. 1A, 1B, 2A, and 2B. Method 500 is a method for determining the position of the line according to the input image in the step S330. Thus, method 500 may be performed by the position determination module 152. In step S510, the position determination module 152 receives the input image captured by the camera 140. Because the camera 140 is mounted on the spectacle-type display device 100, the image captured by the camera 140 is approximately equivalent to user's view (i.e. what the user sees). In step S520, the position determination module 152 marks up the positions of the human in the input image. The position determination module 152 may use any known image identification or object identification technic to identify the human in the input image. Then, the position determination module 152 marks up the positions of the identified human. Refer to FIG. 6A, FIG. 6A is an illustrative diagram in accordance to the embodiments of the present disclosure. FIG. 6A illustrates the input image which has been marked up. As shown in FIG. 6A, the position determination module 152 marks up the positions of the human in the input image using block BLK1˜BLK12. Alternatively, block BLK1˜BLK12 includes the full body of the human.

In step S530, the position determination module 152 cuts (divides) the input image into multiple areas (referred to as image area below). The position determination module 152 may cut the input image in any way. For example, the position determination module 152 may cut the input image into N*M image areas, and N and M may be any positive integer. N may or may not be equal to M. In some embodiments, each of the image areas has the same size. In step S540, the position determination module 152 cuts (divides) the lenses 120 into multiple areas (referred to as lens area below) in the way that the input image is cut (i.e. in the way that the position determination module 152 cuts the input image into image areas). For example, the lenses 120 are respectively cut into N*M areas. Thus, each lens area corresponds to one image area. In some embodiments, the position determination module 152 assigns coordinates (or number) to the image areas and the lens areas in the same way. One image area and the lens area corresponding to that image area have the same coordinates (or number). For example, refer to FIG. 6B, FIG. 6B is an illustrative diagram in accordance to the embodiments of the present disclosure. In FIG. 6B, the position determination module 152 cuts the input image and the lens 120 into 2*2 areas. The position determination module 152 assigns the coordinates from left to right and from top to bottom in order. The coordinate of image area A1 and lens area B1 are (1, 1), the coordinate of image area A2 and lens area B2 are (1, 2), the coordinate of image area A3 and lens area B3 are (2, 1), and the coordinate of image area A4 and lens area B4 are (2, 2). Thus, image area A1 corresponds to lens area B1, image area A2 corresponds to lens area B2, image area A3 corresponds to lens area B3, and image area A4 corresponds to lens area B4.

In step S550, the position determination module 152 determines the position where the line is displayed on the lenses 120. The position determination module 152 determines a first image area in the input image according to the marked up position. The first image area does not include any human. Then, the position determination module 152 determines to display the line on the first lens area of the lenses 120. The first lens area corresponds to the first image area. In some embodiments, the position determination module 152 may also selects more than one area to display the line.

In some embodiments, the position determination module 152 doesn't perform steps S510˜S540. In these embodiments, the position determination module 152 determines to display the line on the default position of the lenses 120. For example, the default position is the top, bottom, leftmost, or rightmost of the lenses 120, because actors usually stand on the middle of the stage. By doing so, the amount of computation and the process time may be reduced, and the spectacle-type display device 100 can display the line faster.

Thus, by using the position determination module 152, the position determination module 152 in accordance to the embodiments of the present disclosure can avoid the line to block the actors in the view of the user. Refer to FIG. 6C, FIG. 6C illustrates what the user sees through lenses 120. As shown in FIG. 6C, because actors are in the bottom of the image, the position determination module 152 determines to display the line 600 on the top of the lenses 120.

In conclusion, the spectacle-type display device in accordance to the embodiments of the present disclosure can correctly display the line corresponding to the received voice and can display the line (caption) without blocking the actor. Thus, the spectacle-type display device in accordance to the embodiments of the present disclosure can display the correct line at the correct timing and improve the user experience.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A spectacle-type display device, comprising:
a lens;
a micro project device;
a memory; and
a control unit, configured to:
read a line in the memory;
compare an input voice and the line to generate a comparison result;
determine to output the line according to the comparison result; and
control the micro project device to project the line on the lens, in response a determination to output the line.

2. The spectacle-type display device as claimed in claim 1, further comprising:
a microphone, configured to receive the input voice.

3. The spectacle-type display device as claimed in claim 2, wherein the microphone is a directional microphone.

4. The spectacle-type display device as claimed in claim 1, wherein the input voice consists of a plurality of voice words, and the line consists of a plurality of line words;
wherein the control unit is further configured to:
determine whether the voice words match vocalization of voice corresponding to the line words;
calculate a number of matching words, wherein the number of matching words is the number of voice words that match the line words; and
calculate an accuracy rate;
wherein the comparison result is the accuracy rate.

5. The spectacle-type display device as claimed in claim 4, wherein the control unit outputs the line when the control unit determines that the accuracy rate is higher than a first threshold.

6. The spectacle-type display device as claimed in claim 5, wherein the control unit doesn't output the line when the control unit determines that the accuracy rate is lower than a second threshold.

7. The spectacle-type display device as claimed in claim 1, wherein the control unit is further configured to determine the position where the line is displayed on the lens.

8. The spectacle-type display device as claimed in claim 7, wherein the control unit displays the line on the top or bottom of the lens.

9. The spectacle-type display device as claimed in claim 1, further comprising:
a camera, configured to capture an input image;
wherein the control unit is further configured to:
mark up a position of at least one human in the input image;
determine to display the line on a first lens area of the lens, wherein the first lens area doesn't include the at least one human.

10. The spectacle-type display device as claimed in claim 2, wherein the microphone is placed in front of a stage or on the stage.
